(19) United States
(12) Patent Application Publication
(10) Pub. No.: US 2026/0313048 A1
(43) Pub. Date: Oct. 8, 2026

(54) MOBILE DEVICE VISOR ASSEMBLY AND ACCESSORIES

(71) Applicant: Kathryn Perkins, Racine, WI (US)

(72) Inventor: Kathryn Perkins, Racine, WI (US)

(21) Appl. No.: 19/171,787

(22) Filed: Apr. 7, 2025

(51) Int. Cl. H04M 1/02; F16B 2/22; F16M 13/02

(52) U.S. Cl. CPC H04M 1/026; F16B 2/22; F16M 13/022; H04M 1/0203

(57) ABSTRACT

A mobile device visor assembly to attach to a mobile device, the mobile device visor assembly including a visor clip assembly to hingedly attach the mobile device visor assembly to the mobile device, and a main visor hingedly attached to the visor clip assembly to shield a screen of the mobile device from external light when the main visor is in an open position, and to cover a camera lens of the mobile device when the main visor is in a closed position.

### BACKGROUND

### 1. Field

The present general inventive concept relates generally to a visor, and particularly, to a mobile device visor assembly and accessories.

### 2. Description of the Related Art

Mobile devices, such as cellular/mobile telephones, personal data assistants (PDAs), tablet computers, and laptop computers, have become increasingly popular in recent times.

Mobile telephone owners, however, are familiar with the struggle of dealing with a smudged phone screen or the glare from sunlight that obscures the clarity of content displayed on the device when it is needed the most. Finding the perfect method or having access to necessary supplies to clean the screen or prevent glare, however, can be incredibly challenging especially when individuals are on the go.

Therefore, there is a need for a method of preventing glare on a mobile telephone screen.

There is also a need for accessories that allow for easy access to cleaning supplies for a screen of a mobile telephone.

### SUMMARY

The present general inventive concept provides a mobile device visorassembly.

Additional features and utilities of the present general inventive concept will be set forth in part in the description which follows and, in part, will be obvious from the description, or may be learned by practice of the general inventive concept.

The foregoing and/or other features and utilities of the present general inventive concept may be achieved by providing a mobile device visor assembly to attach to a mobile device, the mobile device visor assembly including a visor clip assembly to hingedly attach the mobile device visor assembly to the mobile device, and a main visor hingedly attached to the visor clip assembly to shield a screen of the mobile device from external light when the main visor is in an open position, and to cover a camera lens of the mobile device when the main visor is in a closed position.

The mobile device visor assembly may further include a first side visor hingedly attached to a first side portion of the main visor, and a second side visor hingedly attached to a second side portion of the main visor.

The mobile device visor assembly may further include a hinge assembly to attach the main visor to the visor clip assembly, the hinge assembly including a hinge main body, a plurality of visor flip hinges hingedly attached to the hinge main body to the visor clip assembly to allow the main visor to hingedly flip 180-degrees from a first side of the mobile device to a second side of the mobile device, and a visor attachment portion hingedly attached to the main visor to allow the main visor to swing from an open position to a closed position.

The visor clip assembly may further include a visor clip to attach the mobile device visor assembly to the mobile device, and a hinge assembly attachment portion to hingedly attach the visor clip assembly to the plurality of visor flip hinges.

### BRIEF DESCRIPTION OF THE DRAWINGS

These and/or other features and utilities of the present generally inventive concept will become apparent and more readily appreciated from the following description of the embodiments, taken in conjunction with the accompanying drawings of which:

FIG. 1A illustrates a front elevational top view of a mobile device visor assembly in an open position, according to an exemplary embodiment of the present general inventive concept;

FIG. 1B illustrates a rear elevational top view of the mobile device visor assembly in the open position of FIG. 1A, according to an exemplary embodiment of the present general inventive concept;

FIG. 1C illustrates another rear elevational top view of the mobile device visor assembly in another open position, according to an exemplary embodiment of the present general inventive concept; and

FIG. 1D illustrates a rear elevational top view of the mobile device visor assembly of FIG. 1C in a closed position, according to an exemplary embodiment of the present general inventive concept.

### DETAILED DESCRIPTION

Various example embodiments (a.k.a., exemplary embodiments) will now be described more fully with reference to the accompanying drawings in which some example embodiments are illustrated. In the figures, the thicknesses of lines, layers and/or regions may be exaggerated for clarity.

Accordingly, while example embodiments are capable of various modifications and alternative forms, embodiments thereof are shown by way of example in the figures and will herein be described in detail. It should be understood, however, that there is no intent to limit example embodiments to the particular forms disclosed, but on the contrary, example embodiments are to cover all modifications, equivalents, and alternatives falling within the scope of the disclosure. Like numbers refer to like/similar elements throughout the detailed description.

It is understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (e.g., “between” versus “directly between,” “adjacent” versus “directly adjacent,” etc.).

The terminology used herein is for the purpose of describing particular embodiments only and is not intended to be limiting of example embodiments. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements and/or components, but do not preclude the presence or addition of one or more other features, integers, steps, operations, elements, components and/or groups thereof.

Unless otherwise defined, all terms (including technical and scientific terms) used herein have the same meaning as commonly understood by one of ordinary skill in the art to which example embodiments belong. It will be further understood that terms, e.g., those defined in commonly used dictionaries, should be interpreted as having a meaning that is consistent with their meaning in the context of the relevant art. However, should the present disclosure give a specific meaning to a term deviating from a meaning commonly understood by one of ordinary skill, this meaning is to be taken into account in the specific context this definition is given herein.

### LIST OF COMPONENTS

Mobile Device 1
Mobile Device Screen 1a
Mobile Device Camera Lens 1b
Cleaning Cloth 10
First Accessory 20
Ring 30
Second Accessory 40
Mobile Device Visor Assembly 100
Visor Clip Assembly 110
Visor Clip 111
Hinge Assembly Attachment Portion 112
Hinge Assembly 120
Hinge Main Body 121
Visor Flip Hinges 122
Visor Attachment Portion 123
Main Visor 130
Visor Pocket 131
Visor Swing Hinges 132
First Side Visor Attachment Portion
133 Second Side Visor Attachment Portion
134 First Side Visor 140
First Side Visor Hinges 141
Second Side Visor 150
Second Side Visor Hinges 151
First Accessory Holder 200
First Accessory Holder Main Body 210
First Accessory Holder Clip 220
First Accessory Holder Aperture 230
Corner Clip Assembly 300
Corner Clip Main Body 310
Corner Clip Clipping Portion 320
Corner Clip Ring Receiver 330
Second Accessory Holder 400
Second Accessory Holder Main Body 410
First Accessory Holder Clip 420
Second Accessory Holder Aperture 420
Second Accessory Holder Ring Receiver 430

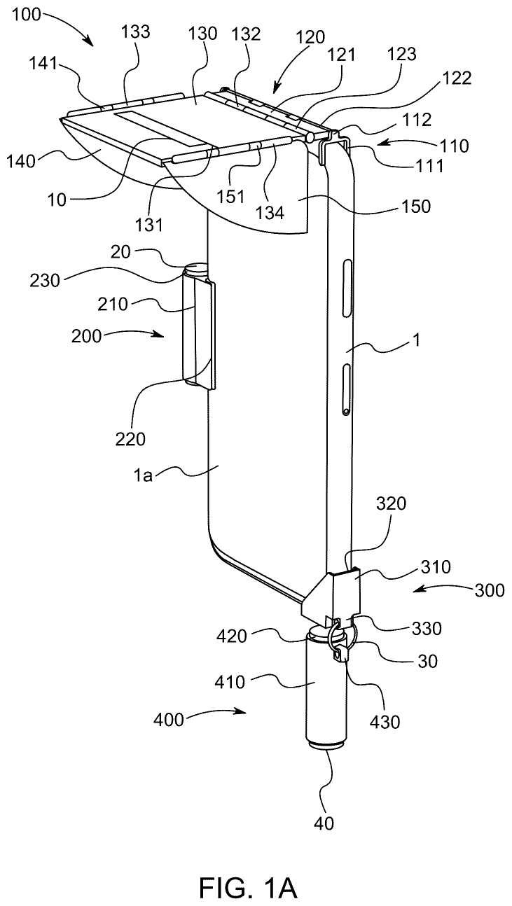

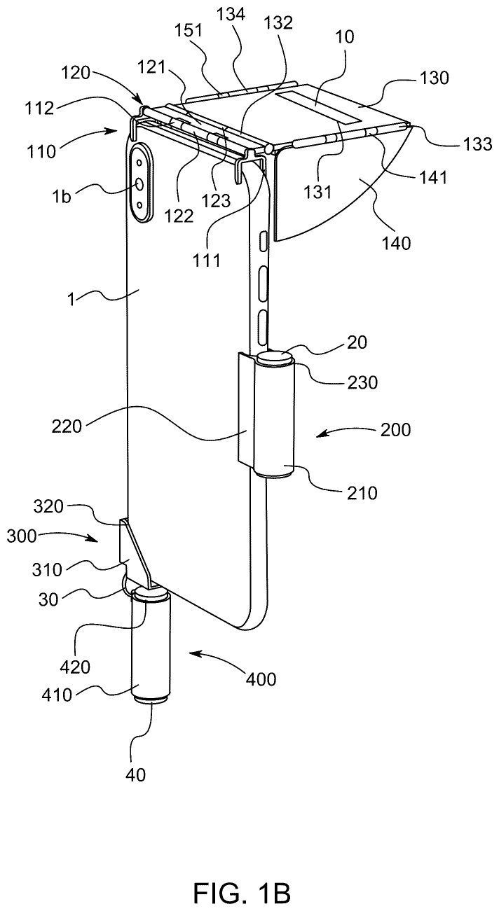

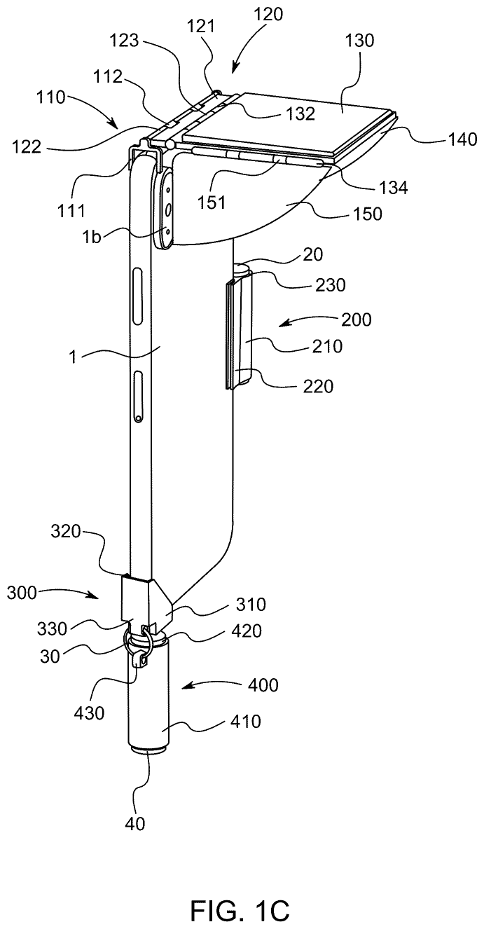

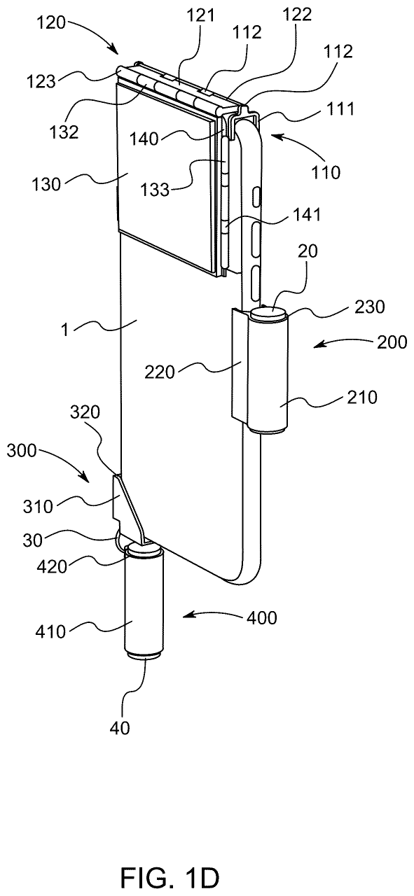

FIG. 1A illustrates a front elevational top view of a mobile device visor assembly 100 in an open position, according to an exemplary embodiment of the present general inventive concept.

FIG. 1B illustrates a rear elevational top view of the mobile device visor assembly 100 in the open position of FIG. 1A, according to an exemplary embodiment of the present general inventive concept.

FIG. 1C illustrates another rear elevational top view of the mobile device visor assembly 100 in another open position, according to an exemplary embodiment of the present general inventive concept.

FIG. 1D illustrates a rear elevational top view of the mobile device visor assembly 100 of FIG. 1C in a closed position, according to an exemplary embodiment of the present general inventive concept.

The mobile device visor assembly 100, and all components therein and related thereto, may be constructed from at least one of metal, plastic, wood, ceramic, and rubber, etc., but is not limited thereto.

Referring to FIGS. 1A through 1D, a mobile device 1 is depicted as a mobile telephone, which includes a mobile device screen 1a on a front portion thereof, and a mobile device camera lens 1b on a rear portion thereof. However, the mobile device 1 may be a cellular telephone, a personal digital assistant, a tablet computer, a laptop computer, etc., but is not limited thereto.

Referring to FIGS. 1A through 1D, the mobile device visor assembly 100 may include a visor clip assembly 110, a hinge assembly 120, a main visor 130, a first side visor 140, and a second side visor 150, but is not limited thereto.

The mobile device visor assembly 100 may attach to a top portion of the mobile device 1 via the visor clip assembly 110.

The visor clip assembly 110 may include a visor clip 111, and a hinge assembly attachment portion 112, but is not limited thereto.

The visor clip 111 may be a clip or any other type of clip-like mechanism to allow the visor clip assembly 110 to attach to a top portion of the mobile device 1.

The hinge assembly attachment portion 112 may be a rod, pole, or any other device to allow the hinge assembly 120 to attach to the visor clip assembly 110.

The hinge assembly 120 may include a hinge main body 121, a plurality of visor flip hinges 122, and a visor attachment portion 123, but is not limited thereto.

The hinge main body 121 may include the plurality of visor flip hinges 122 disposed on one side thereof to allow the hinge assembly 120 to attach to the visor clip assembly 110, and may also include the visor attachment portion 123 disposed on another side thereof to allow the hinge assembly 120 to attach to the main visor 130.

The main visor 130 may include a visor pocket 131, a plurality of visor swing hinges 132, a first side visor attachment portion 133, and a second side visor attachment portion 134, but is not limited thereto.

The visor pocket 131 may be a slit and/or a zippered opening within a surface the main visor 130 to allow insertion of a cleaning cloth 10 within the visor pocket 131. Although FIG. 1A depicts the visor pocket 131 to be disposed within a first surface of the main visor 130, the visor pocket 131 may alternatively or additionally be disposed on a second surface on an opposite side of the main visor 130.

The plurality of visor swing hinges 132 may be disposed at a portion of the main visor 130 that is closest to the hinge assembly 120.

The first side visor attachment portion 133 may be disposed at a first side portion of the main visor 130.

The second side visor attachment portion 134 may be disposed at a second side portion of the main visor 130.

As illustrated in FIG. 1A, the hinge assembly attachment portion 112 of the visor clip assembly 110 may be attached to the plurality of visor flip hinges 122, in order to allow the main visor 130 to rotate about the hinge assembly attachment portion 112 via the plurality of visor flip hinges 122, as illustrated in FIG. 1C.

Also as illustrated in FIG. 1A, the visor attachment portion 123 of the hinge assembly 120 may be attached to the plurality of visor swing hinges 132, in order to allow the main visor 130 to swing up and down about the visor attachment portion 123 via the plurality of visor swing hinges 132, as illustrated in FIG. 1D.

The first side visor 140 may include a plurality of first side visor hinges 141, but is not limited thereto.

The first side visor 140 may be hingedly connected to the main visor 130 at the first side portion of the main visor 130. Specifically, the plurality of first side visor hinges 141 of the first side visor 140 may be hingedly connected to the first side visor attachment portion 133 of the main visor 130. As such, the first side visor 140 may be opened as illustrated in FIG. 1A, or alternatively, may be closed as illustrated in FIG. 1D.

The second side visor 150 may include a plurality of second side visor hinges 151, but is not limited thereto.

The second side visor 150 may be hingedly connected to the main visor 130 at the second side portion of the main visor 130. Specifically, the plurality of second side visor hinges 151 of the second side visor 150 may be hingedly connected to the second side visor attachment portion 134 of the main visor 130. As such, the second side visor 150 may be opened as illustrated in FIG. 1A, or alternatively, may be closed as illustrated in FIG. 1D.

As illustrated in FIG. 1A, when the main visor 130 is swung open to be disposed perpendicular with respect to the mobile device 1, and when the first side visor 140 and the second side visor 150 are in an open position, the mobile device screen 1a may be shielded from sunlight and/or other external and/or ambient light.

The mobile device visor assembly 100 may also include additional accessories to allow for increased utility for a user, such as a first accessory holder 200, a corner clip assembly 300, and a second accessory holder 400.

The first accessory holder 200 may include a first accessory holder main body 210, a first accessory holder clip 220, and a first accessory holder aperture 230, but is not limited thereto.

The first accessory holder main body 210 may have a shape to accommodate a first accessory 20 within the first accessory holder aperture 230. The first accessory 20 may be a small spray bottle including a mobile device screen cleaner therewithin, a lipstick, a chap stick, or any other article desired by a user.

The first accessory holder clip 220 may be disposed on the first accessory holder main body 210 to allow the first accessory holder 200 to be attached to the mobile device 1.

The corner clip assembly 300 may include a corner clip main body 310, a corner clip clipping portion 320, and a corner clip ring receiver 330, but is not limitedthereto.

The corner clip clipping portion 320 may be disposed on the corner clip main body 310 to allow the corner clip assembly 300 to be attached to a corner of the mobile device 1.

The corner clip ring receiver 330 may be disposed on the corner clip main body 310 to allow a portion of a ring 30 to be thread therethrough.

The second accessory holder 400 may include a second accessory holder main body 410, a first accessory holder clip 420, a second accessory holder aperture 420, and a second accessory holder ring receiver 430, but is not limited thereto.

The second accessory holder main body 410 may have a shape to accommodate a second accessory 40 within the second accessory holder aperture 420. The second accessory 40 may be a small spray bottle including a mobile device screen cleaner therewithin, a lipstick, a chap stick, or any other article desired by a user.

The second accessory holder ring receiver 430 may be disposed on the second accessory holder main body 410 to allow another portion of the ring 30 to be thread therethrough, such that the corner clip assembly 300 is connected to the second accessory holder 400 via the ring 30.

The combination of the mobile device visor assembly 100, the first accessory holder 200, the corner clip assembly 300, and the second accessory holder 400, when connected to the mobile device 1, may eliminates the problem of dealing with a smudgy or dirtied mobile screen 1a by conveniently providing cleaning materials within a finger's reach, while also simultaneously adding protection to the mobile device camera lens 1b, and shielding both the mobile device camera lens 1b and the mobile device screen 1a from bright light or reflections.

The present general inventive concept may include a mobile device visor assembly 100 to attach to a mobile device 1, the mobile device visor assembly 100 including a visor clip assembly 110 to hingedly attach the mobile device visor assembly 100 to the mobile device 1, and a main visor 130 hingedly attached to the visor clip assembly 110 to shield a screen 1a of the mobile device 1 from external light when the main visor 130 is in an open position, and to cover a camera lens 1b of the mobile device 1 when the main visor 130 is in a closed position.

The mobile device visor assembly 100 may further include a first side visor 140 hingedly attached to a first side portion of the main visor 130, and a second side visor 150 hingedly attached to a second side portion of the main visor 130.

The mobile device visor assembly 100 may further include a hinge assembly 120 to attach the main visor 130 to the visor clip assembly 110, the hinge assembly 120 including a hinge main body 121, a plurality of visor flip hinges 122 hingedly attached to the hinge main body 121 to the visor clip assembly 110 to allow the main visor 130 to hingedly flip 180-degrees from a first side of the mobile device 1 to a second side of the mobile device 1, and a visor attachment portion 123 hingedly attached to the main visor 130 to allow the main visor 130 to swing from an open position to a closed position.

The visor clip assembly 110 may further include a visor clip 111 to attach the mobile device visor assembly 100 to the mobile device 1, and a hinge assembly attachment portion 112 to hingedly attach the visor clip assembly 110 to the plurality of visor flip hinges 122.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

1. A mobile device visor assembly to attach to a mobile device, the mobile device visor assembly comprising:
a visor clip assembly to hingedly attach the mobile device visor assembly to the mobile device; and
a main visor hingedly attached to the visor clip assembly to shield a screen of the mobile device from external light when the main visor is in an open position, and to cover a camera lens of the mobile device when the main visor is in a closed position.

2. The mobile device visor assembly of claim 1, further comprising:
a first side visor hingedly attached to a first side portion of the main visor; and
a second side visor hingedly attached to a second side portion of the main visor.

3. The mobile device visor assembly of claim 1, further comprising:
a hinge assembly to attach the main visor to the visor clip assembly, the hinge assembly comprising;
a hinge main body,
a plurality of visor flip hinges hingedly attached to the hinge main body to the visor clip assembly to allow the main visor to hingedly flip 180-degrees from a first side of the mobile device to a second side of the mobile device, and
a visor attachment portion hingedly attached to the main visor to allow the main visor to swing from an open position to a closed position.

4. The mobile device visor assembly of claim 3, wherein the visor clip assembly further comprises:
a visor clip to attach the mobile device visor assembly to the mobile device; and
a hinge assembly attachment portion to attach the visor clip assembly to the plurality of visor flip hinges.
